(19) United States
(12) Patent Application Publication
(10) Pub. No.: US 2012/0018432 A1
(43) Pub. Date: Jan. 26, 2012

(54) DEVICE FOR ASSEMBLING COMPONENTS DEFINING A COOKING TOOL

(76) Inventors: Mathieu Lion, Paris (FR); Anne Tanguy, Paris (FR)

(21) Appl. No.: 13/145,590

(22) PCT Filed: Jan. 19, 2010
(86) PCT No.: PCT/FR2010/000047

§ 371 Date: Sep. 28, 2011

(30) Foreign Application Priority Data
Jan. 22, 2009 (FR) 09/00272

(51) Int. Cl. A47J 36/04; A47J 36/06

(52) U.S. Cl. 220/378

(57) ABSTRACT

The invention relates to a device for assembling a cooking tool that includes an engagement edge (3) made on a first component of the tool and a reception slit (5) for said engagement edge (3) and made in a second component of the tool. The engagement edge (3) is made of silicone. The reception slit (5) is formed in a silicone portion of the second component. The engagement edge (3) has a flange (7) with a rib (21) and a groove (19) that are mutually adjacent. The reception slit (5) has a flange (13) at least partially conformed so as to be complementary with the flange (7) of the engagement edge (3). In a particular application, the first and second components define the envelope and the bottom of a cooking mould.

The invention relates to a device for assembling elements that are designed to jointly form a kitchen utensil, at least in part.

There are numerous elements of this type. Non-limiting examples include kitchen utensils with lids, such as saucepans, frying pans, pressure cookers, stewpots, steam cookers, baking dishes and others, or even food storage receptacles, such as plastic trays, plastic storage receptacles with detachable lids, storage receptacles with detachable bases, metal storage receptacles with pivoting or detachable lids, glass jars with screw lids, and others.

Storage receptacles, for example, generally have a lid arranged to engage the rest of the receptacle, that is, the container.

This type of assembly can be produced in several different ways.

With regard to receptacles that are made entirely from metal, for example, assembly is often undertaken by clamping the side walls of the container via the walls forming the flange of the lid.

When the side walls are inserted into the lid, said side walls are resiliently deformed towards the interior of the receptacle and the resilience holds said side walls against the flange of the lid.

The strength of this assembly is satisfactory, in so far as the lid is not in practice subjected to any particular force that is likely to cause its removal. The tightness to liquid and gases is mediocre, but it is sufficient for the general use that is made of this type of utensil.

Plastic storage receptacles also have a lid that is firmly held on the rest of the receptacle. The container generally has a smooth or slightly indented upper rim, which is received in a groove, or a notch, that is formed in the rim of the lid. The groove has two straight sides—a uniform side and a side that can be uniform or slightly hollow, depending on the case—that are designed to clamp the rim of the container. This container is made from a fairly rigid plastic material, unlike the lid, which is made from a more flexible plastic material which allows the sides to deform resiliently when the rim of the container engages with the lid and is then held in position.

In terms of the tightness, this type of device is better than those that are commonly used on metal receptacles. This tightness, which is of course sufficient for most uses of this type of receptacle, namely storing foods in a refrigerator, is nevertheless fairly limited: in itself the assembly is fairly permeable to liquids. Furthermore, this type of device can only withstand a limited temperature range, ranging from the normal refrigerator temperature to the ambient temperature. It cannot be used for storage in a freezer or in an oven.

Finally, in order to obtain sufficient strength, the material used to produce the lid nevertheless has to be sufficiently rigid, which makes removal of the lid a potentially awkward operation, requiring a large amount of force to be applied to the lid.

The invention aims to improve this situation. It relates to an assembly device for a kitchen utensil comprising an engagement rim formed on a first element of said utensil and a groove for receiving said engagement rim formed in a second element of said utensil, this being noteworthy in that said engagement rim is made from silicone, that the receiving groove is formed in a silicone portion of said second element, and in that the engagement rim has a side with a rib and a notch that are mutually adjacent, whereas said receiving groove has a side that is shaped at least in part to complement said side of said engagement rim.

As will be seen, the tightness and strength of this type of assembly device are increased relative to existing assembly devices of this type.

Further features and advantages of the invention will become apparent upon reading the following detailed description, with reference to the appended drawings, in which:

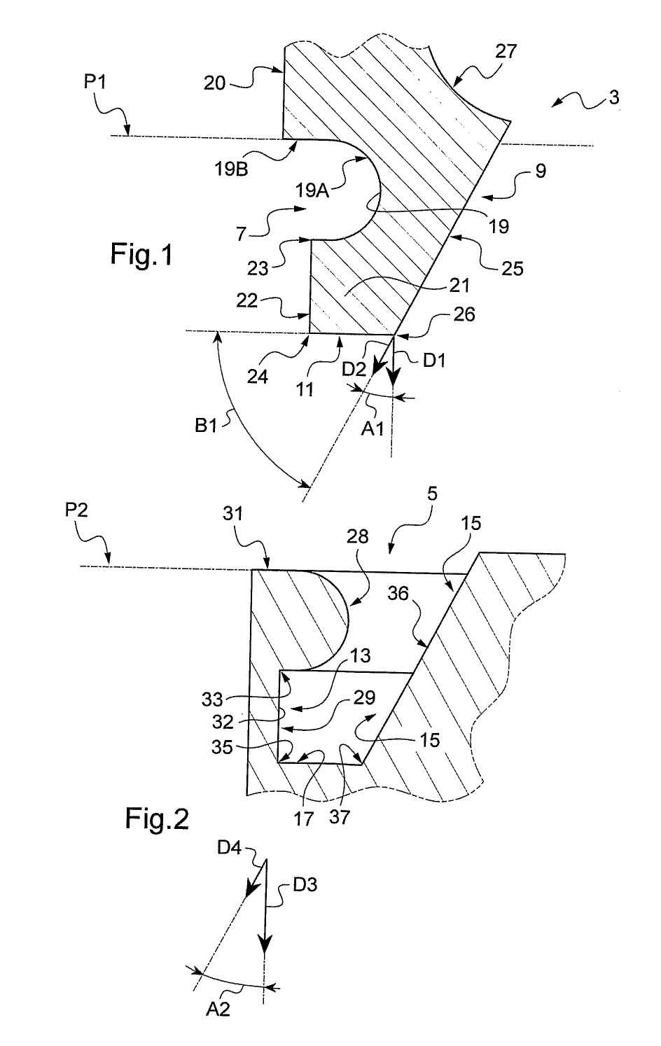

FIG. 1 shows a first part of an assembly device according to the invention, in a cross-sectional view,

FIG. 2 shows a second part of the assembly device according to the invention, in a cross-sectional view,

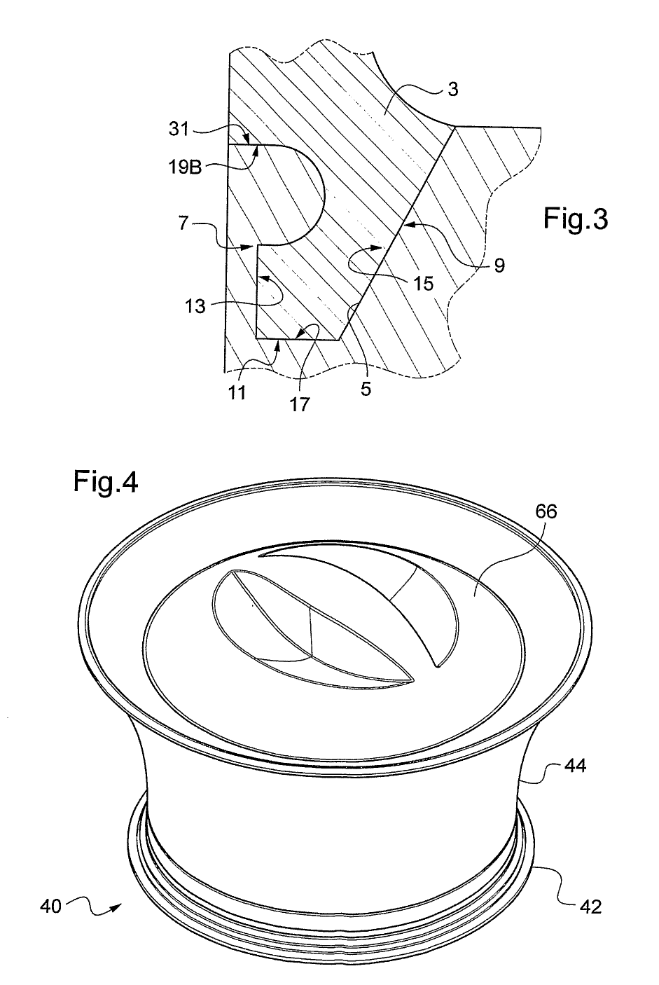

FIG. 3 shows the assembly device according to the invention, in a cross-sectional view,

FIG. 4 shows a kitchen utensil provided with the assembly device of FIG. 1, in a perspective view,

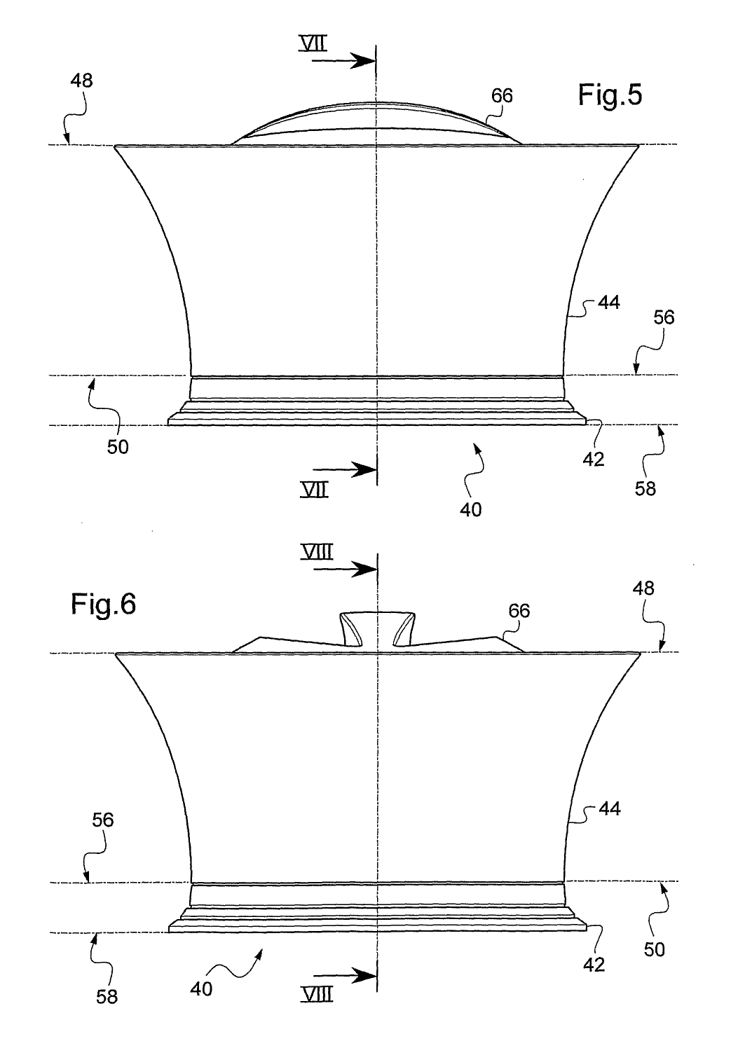

FIG. 5 shows the utensil of FIG. 2, in a front view,

FIG. 6 shows the utensil of FIG. 2, in a side view,

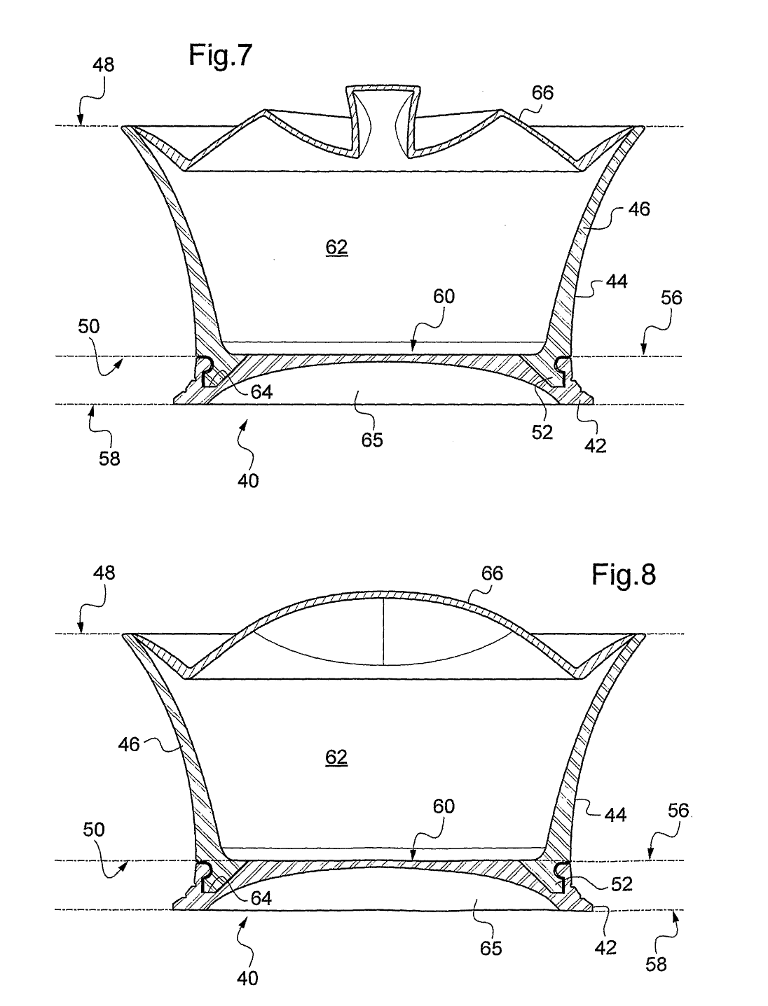

FIG. 7 shows the utensil of FIG. 2, in a section along a line V-V, that can be seen in FIG. 3, and

FIG. 8 shows the utensil of FIG. 2, in a section along a line VI-VI, that can be seen in FIG. 4.

The appended drawings can be used not only to complement the invention, but also to assist in its definition, where necessary.

FIGS. 1, 2 and 3 illustrate a device 1 for assembling elements that are designed to jointly form a kitchen utensil, or at least part of such a utensil.

In other words, the assembly device 1 is designed for kitchen utensils having at least two parts, which parts must be firmly, but reversibly, and even temporarily, joined together for use.

The assembly device 1 comprises an engagement rim 3, shown in isolation in FIG. 1, which is designed to project from a first constituent element of the kitchen utensil.

The assembly device 1 further comprises a groove 5 for receiving said engagement rim 3, which is shown in isolation in FIG. 2. The receiving groove is formed in a second constituent element of the kitchen utensil.

The engagement rim 3 is made from silicone. The receiving groove 5 is formed in a part, made from silicone, of the second element of the utensil.

The assembly device 1 is thus compatible with most food uses, such as storage or cooking.

This means that the assembly device 1 can come into contact with foods without any risk of spoilage thereof.

This also means that the assembly device 1 is capable of operating over a wide temperature range, from freezing temperatures (of approximately −20° C.) to normal cooking temperatures (up to approximately 300° C.). However, the operating temperatures of the assembly device 1 are not limited to the values mentioned herein, these values being given by way of example only.

Finally, this means that the assembly device 1 can be used in a wide range of kitchen utensils, such as all types of dishes, storage receptacles, freezer trays and others.

Preferably, the engagement rim 3 is made entirely from silicone, for example due to simplicity of manufacture or to provide it with some flexibility if this is required.

However, this does not prevent a core, for example a metal core, from being embedded in the silicone of the engagement rim 3, if the envisaged application requires a more rigid engagement rim 3.

In order to simplify manufacture of the assembly device 1, and/or to provide it with optimal efficiency, particularly in terms of strength and tightness, the engagement rim 3 and the part of the second element in which the receiving groove 5 is formed are preferably made from the same silicone.

In general, any grade of silicone can be used: from silicones having a hardness of 00 A, that is, extremely flexible, to those having a hardness of 85 A, that is, extremely hard, of the peroxide catalyst, plate or other type, and/or of the “Heat Cured Rubber” (vulcanised silicones) or “Liquid Silicone Rubber” (liquid silicones) type.

However, the use of a particular grade of silicone can be dictated by the envisaged application. For example, regulations may exist that limit the materials that can be used in the foods field.

Lengthwise, the engagement rim 3 can generally extend along any path, depending on the respective functions of the first and second elements of the kitchen utensil and/or the shape of said elements.

In particular, this path can describe a closed, regular or irregular curve. For example, the engagement rim 3 can generally extend over a circle, a square, a rectangle or an ellipse. For the sake of simplicity, these will all be referred to herein as the length of the engagement rim 3.

The engagement rim 3 can also extend over a rectilinear segment.

As an option, the rim 3 can form a contour of the first element.

The engagement rim 3 has a uniform cross-section, at least over the majority of its path.

Lengthwise, the receiving groove 5 extends along a path that corresponds, over at least a portion, to the general path of the engagement rim 3.

The engagement rim 3 and the receiving groove 5 can generally extend along similar curves. However, some applications can require, or simply render desirable, a difference in the length of the path between the engagement rim 3 and the receiving groove 5. This is the case, for example, when the shape of one of the constituent elements of the utensil makes it easier to produce a rim, or a groove, that is longer than is effectively necessary to house the relevant rim in the groove.

Specific reference is made to FIG. 1.

Transversely, the engagement rim 3 projects from a base plane P1, orthogonally to said base plane P1.

The engagement rim 3 has a first side, or first engagement side 7, and a second side, or second engagement side 9, that are mutually opposed and that are joined together by a crest surface 11.

Transversely, the first engagement side 7 has a generally straight course relative to the base plane P1. In other words, the first engagement side 7 extends generally in a direction, known as the first direction D1, which is basically orthogonal to the base plane P1.

Transversely, the second engagement side 9 has a course that is generally oblique relative to the base plane P1. In other words, the second engagement side 9 extends generally in a direction, known as the second direction D2, which forms an angle of inclination A1 with the first direction D1.

The angle of inclination A1 is such that the gross thickness of the engagement rim 3, that is, the volume that is generally defined by the first engagement side 7 and the second engagement side 9 together, decreases the farther it is from the reference plane P1.

The value of the first angle A1 can be selected in particular as a function of the envisaged application. This angle of inclination A1 in this case is in the region of 30°.

The crest surface 11 is flat and is arranged perpendicular to the first engagement side 7. The crest surface 11 is generally parallel to the reference plane P1. In other words, the crest surface 11 and the second direction D2 together form a selected angle B1, in this case in the region of 60°.

The crest surface 11 constitutes an end, or terminal, surface of the engagement rim 3. The height of the engagement rim 3 can be defined as the extent of this rim that is included between the base plane P1 and the crest surface 11.

The first engagement side 7 has a notch, or base notch 19, that extends along the length of said first side 7, that is, along the path of the engagement rim 3. The base notch 19 is open on the first engagement side 7.

In cross-section, the first engagement side 7 also has a rib, or end rib 21, that projects from said first side 7. The base notch 19 and the end rib 21 are arranged close to one another.

In this case, the base notch 19 is also located in the immediate region of the base plane P1, that is, of the base of the engagement rim 3. The end rib 21 is arranged in the immediate vicinity of the crest surface 11, and the base notch 19 and the end rib 21 are mutually adjacent.

The base notch 19 is formed by a first portion 19A, having a cross-section in the arc of a circle, and by a second flat portion 19B that connects to the first portion at an end rim of said portion that is remote from the end rib 21.

In this case, the first portion 19A has a semi-circular cross-section. The junction between the first portion 19A and the second portion 19B is made in a continuous manner. In other words, the second portion 19B transversely extends the first portion 19A.

The second portion 19B of the base notch 19 extends perpendicular to the first direction D1.

The second portion 19B is included in the base plane P1. In other words, the second portion 19B forms a base surface for the engagement rim 3. The longitudinal rim of the second portion 19B remote from the first portion 19A in this case connects to a first wall 20 of the first element of the utensil, forming a sharp edge (without reference numeral).

The end rib 21 has an upper surface 22. This upper surface 22 is in this case formed in the shape of a flat surface that extends parallel to the first direction D1.

A longitudinal rim of the upper surface 22 connects directly to the longitudinal rim of the first portion 19A remote from the second portion 19B of the base notch 19. The junction between the upper surface 22 of the end rib 21 and the first portion 19A of the base notch 19 is formed as a sharp edge, or first sharp edge 23.

The longitudinal rim of this upper surface 22 remote from the notch 19 connects directly to the longitudinal rim close to the crest surface 11. The junction between the upper surface 22 of the end rib 21 and the crest surface 11 of the engagement rim 3 is formed as a sharp edge, or second sharp edge 24.

The upper surface 22 of the end rib 21 is slightly offset relative to the longitudinal rim of the second portion 19B remote from the first portion 19A of the base notch 19.

The upper surface 22 of the end rib 21 and the crest surface 11 of the engagement rim 3 are together arranged in a basically perpendicular manner.

In this case, the first engagement side 7 is practically formed by the base notch 19 and by the end rib 21, exclusively. In cross-section and in height, this base notch 19 and this end rib 21 extend over respective distances that are basically identical. In other words, they each occupy approximately half the height of the engagement rim 3.

The second side 9 of the engagement rim 3 comprises a uniform surface, or uniform engagement surface 25, without a rib or a notch. In this case, the second engagement side 9 is exclusively formed by this uniform engagement surface 25. This surface is generally smooth.

A longitudinal rim of the uniform engagement surface 25 connects to the longitudinal rim of the crest surface 11 remote from the first engagement side 7. The junction between the crest surface 11 of the engagement rim 3 and the uniform engagement surface 25 of the second engagement side 9 is shaped as a sharp edge, or third sharp edge 26.

The other longitudinal rim of the uniform engagement surface 25 connects to a second wall 27 of the first element of the utensil by forming a sharp edge (without reference numeral). The connection of this uniform surface 25 to said second wall is undertaken beyond the base plane P1, that is, on the side of the plane P1 that is opposite the crest surface 11. This constitutes only one option: the connection can also be provided at the base plane P1, or slightly offset therefrom.

Notably, it can be seen from FIG. 1 that the engagement rim 3 has a cross-section, the general shape of which corresponds to a rectangular trapezoid: the sides of this trapezoid that are parallel with one another are formed by the base plane P1 and the crest surface 11, respectively, and the right-hand side by the first engagement side 7. Still in cross-section and in height, the engagement rim 3 can be seen as a superposition of two extended portions that are essentially equally divided:
half of the height of the engagement rim 3 constitutes a portion forming an end that is almost perfectly trapezoidal and rectangular in shape, comprising the upper surface 23, the crest surface 11 and a part of the uniform engagement surface 24;
half of the height of the engagement rim 3 constitutes a portion forming a base that is trapezoidal and rectangular (merely generally), comprising the engagement notch 19, the remaining part of the uniform engagement surface 25 and the base plane P1.

The portions forming the base and the end respectively have basically equal volumes of material. This facilitates the moulding of the engagement rim 3.

Specific reference is now made to FIG. 2.

Lengthwise, the receiving groove 5 has a uniform cross-section over practically its entire extent.

The receiving groove 5 is open on an upper plane P2 and generally extends to this upper plane P2 in an orthogonal manner.

The receiving groove 5 has a first side, or first receiving side 13, a second side, or second receiving side 15, opposite the first receiving side 13, and a base 17, which connects the first side 13 and the second receiving sides 15 together.

The first receiving side 13 has a generally straight course relative to the upper plane P2. In other words, this first side 13 generally extends in a direction, known as the third direction D3, which is basically orthogonal to the upper plane P2.

The first receiving side 13 is formed so as to be basically complementary to the first engagement side 7. This first side 13 thus has a rib, known as the upper rib 28, and a notch, known as the lower notch 29, adjacent to the upper rib 28.

The upper rib 28 projects from the first receiving side 13, perpendicular to the third direction D3, towards the inside of the receiving groove 5.

The upper rib 28 is formed so as to be complementary to the first portion 19A of the base notch 19. In this case the upper rib 27 is semi-circular in cross-section. This upper rib 27 is adjacent to the upper plane P2.

The longitudinal rim of the upper rib 28 close to the upper plane P2 connects to the longitudinal rim of a flat terminal surface 31. This terminal surface 31 in this case extends perpendicular to the third direction D3, from the longitudinal rim connected to the upper rib 28 to an opposing longitudinal rim that is remote from the receiving rib 5. The connection of the upper rib 28 to the terminal surface 31 is formed so that it is continuous.

The lower notch 29 extends transversely, perpendicular to the third direction D3. This notch 29 is formed so as to be complementary to the end rib 21. The lower notch 29 has a base surface 32, which is complementary to the upper surface 23 of the end rib 21. In this case, this base surface 32 is flat and extends in the third direction D3. The longitudinal rim of this base surface 32, said rim being remote from the base 17, connects directly to the longitudinal rim of the upper rib 28 remote from the upper surface P2, forming a first corner 33.

The longitudinal rim of the base surface 32 close to the base 17 connects to the longitudinal rim of said base, which is remote from the second receiving side 15, forming a second corner 35.

The second receiving side 15 generally extends along a direction, or fourth direction D4, that is inclined relative to the third direction D3 in such a way that, in cross-section, the receiving groove 5 opens out from the base 17 towards the upper plane P2. In this case, the third direction D3 and the fourth direction D4 mutually form an angle, or second angle A2, that is practically identical to the first angle A1. In this case, the second angle A2 is in the region of 30°.

The second receiving side 15 is formed so as to be complementary to the second engagement side 9. The second receiving side 15 is in this case exclusively formed by a uniform surface, or by a flat uniform receiving surface 36, a longitudinal rim of which connects to the base 17 in a corner, or third corner 37. The longitudinal rim of the uniform receiving surface 36 remote from the base 17 connects to a first surface of the second element of the utensil, thus forming a sharp edge (without reference numeral). The connection of this last surface to the receiving surface 36 occurs just beyond the upper plane P2, that is, on the side of said plane P2 that is opposite the base 17.

The shape of the base 17 is complementary to the crest surface 11 of the engagement rim 3. In this case, the base 17 is formed as a flat surface that extends perpendicular to the third direction D3.

More specific reference will now be made to FIG. 3, which shows the engagement rim 3 housed in the receiving groove 5.

The receiving groove 5 is designed to house, with complementary shaping, all of the engagement rim 3, in particular its first side 7 and its second side 9. In cross-section, the shape of the groove 5 is complementary to the engagement rim 3.

This housing of the engagement rim 3 in the receiving rib 5 places the uniform engagement surface 25 and the uniform receiving surface 36 in close contact with one another, basically in planar surface contact. The housing also provokes the engagement of the third sharp edge 26 in the third corner 37. The upper rib 28 closely engages with the first portion 19A of the notch 19, whereas the end rib 21 engages with the lower rib 29, each time making contact with the respective external surfaces. In addition, the second portion 19B bears against the terminal surface 31.

The contact between the second sides 9 and 15 greatly contributes to the tightness of the assembly device 1. Due to the respective surface finish produced on these second sides 9 and 15, a suction effect is created between these sides, particularly between the uniform engagement surface 25 and the uniform receiving surface 36, which significantly contributes to the tightness of the assembly device. As an option, the same surface finish, or a similar surface finish, is produced on the first sides 7 and 13 in order to further improve the tightness of the device. Of course, this suction effect also contributes to the strength of the assembly. This same surface finish can be produced for the crest surface 11 and the base surface 32.

The contact between the first sides 7 and 13 greatly contributes to holding the elements of the utensil together and ensures the strength of the assembly. Nevertheless, the respective functions of these sides cannot be limited thereto. In fact, the first sides also fulfill part of the tightness function, particularly if a major load is applied to the assembly device 1, in the direction D1. Furthermore, due to the flexibility of the silicone, the second sides, by deforming in part, absorb some of these forces, making the first sides more resistant to the load.

Due to the flexibility of the silicone, and to the specific shape of the assembly device 1, the engagement rim 3 and the receiving groove 5 can be easily connected together. They can also be removed from one another just as easily. In particular, this engagement and disengagement occurs without any plastic deformation of the assembly device 1, which is thus fully reversible. Holding the engagement rim 3 in the receiving groove 5 does not, or does not often, require the resilience of the sides of the receiving rib 5, nor that of the sides of the engagement rim 3. Holding is ensured as a result of the specific shape of the receiving groove 5 and of the engagement rim 3, and notably due to the complementarity of these shapes. Surface contact is obtained between the first side 7 and the second side 9 of the rim 3 and the first side 13 and the second side 15 of the groove 5, respectively. At each moment, surface contact can be the place of a suction effect, which is beneficial in terms of tightness and strength.

The assembly device 1, which is noteworthy due to the specific shape of the engagement rim 3 and of the receiving groove 5, allows reversible assembly of the elements, in particular of elements designed to form a cooking element.

This assembly is tight to most foodstuff substances that are used, particularly to liquids and to gases. The performance of this tightness is maintained regardless of the temperature to which the rim 3 and the groove 5 are exposed, at least in terms of those temperatures that can be encountered in cooking, that is, between approximately −20° C. and 300° C.

Surprisingly, the surface contact obtained at ambient temperature between the first side 7 of the rim 3 and that of the groove 5, on the one hand, and the second side 9 of the rim 3 and that of the groove 5, on the other hand, is maintained at conventional cooking temperatures, as well as at conventional refrigeration temperatures. It follows that this device can be used notably for the assembly of elements of numerous kitchen utensils.

More surprisingly, at a conventional cooking temperature of between 50° C. and 300° C., the tightness of this assembly is further improved.

The assembly formed by the device 1 is highly resistant, at least with regard to stresses directed towards the engagement rim 3. In fact, the application of force directed along the rim 3 is not sufficient to disengage the rim 3 from the groove 5. This disengagement requires a transverse force, applied in such a way that the part of the groove 5 that corresponds to the notch 19 is completely separated from said groove 5. This has the additional effect of allowing the rim 3 to be withdrawn smoothly, without jerks.

The force is not sufficient to impair the tightness, and this allows the device to withstand high loads.

The use of a silicone material is important in that it notably allows the engagement and the disengagement of the assembly device 1 without plastic deformation, whilst providing said device with good rigidity. In fact, silicone allows perfectly resilient parts to be produced, that are highly deformable, but that have good strength and good rigidity under certain loading conditions.

FIGS. 4 to 8 show a cooking dish 40 as an example of a kitchen utensil fitted with the assembly device of FIGS. 1 to 3.

The dish 40 comprises a base element 42 and a body element 44 that are mutually and reversibly assembled by a device similar to the assembly device 1.

The body element 44 mainly comprises a sidewall 46, extending along a closed contour, delimited in height by a first end face 48 and a second end face 50, which are mutually opposed.

The first end face 48 is designed to be located remote from the base element 42.

An engagement rim 52, similar to the engagement rim 3 of FIGS. 1 to 3, projects from the second end face 50. This engagement rim 52 is supported by the sidewall 46 and extends said sidewall.

The first end face 48 is formed as a flat, uniform and smooth surface that extends perpendicular to the height of the sidewall 46. The first end face 48 thus forms a seating platform for the dish 40, that is, a surface via which the dish 40 can rest on a flat surface.

This seating platform is formed as a terminal surface of the side wall 46.

The base element 42 has a first end face 46 and a second end face 58 that are mutually opposed. The second end face 58 is designed to be located remote from the body element 44.

The first end face 56 of the base element 42 has a flat surface 60. The base element 42 has a notch 64 for receiving the engagement rim 52, said notch being similar to the receiving notch 5 of FIGS. 1 to 3, open on the first end face 56 and bordering the flat surface 60.

Once the body element 44 is connected to the base element 42 by engaging with the engagement rim 52 in the groove 64, the flat surface 60 and the inner surface of the sidewall 46 together define an internal volume 62, which can be used as a cooking space.

The seating platform formed on the second end face of the body element 44 in this case provides a considerable advantage for removal of contents.

The second end face 58 of the base element 42 is formed as a flat, smooth and uniform surface that extends perpendicular to the height of the body element 44. The second end face 58 thus constitutes an additional seating platform for the dish 40.

This additional seating platform is separated by a cavity 64 formed in the second end face 58 of the base element 42.

The additional seating platform is in this case produced as a surface that borders the base element 42.

In this case, the body element 44 and the base element 42 are produced in the form of bodies of revolution, but other shapes can be envisaged.

The body element 44 and the base element 42 are preferably produced one-piece castings or mouldings and entirely from silicone, notably to facilitate their manufacture. The flexibility of the sidewall 46 thus further facilitates removal of the contents by modifying the contours of the cooking space 62. The flexibility of the base element 42 allows said element to be easily separated from the body element 44, without jerks, and without having to exert excessive force. In fact, to achieve this it is sufficient to fold part of the base, in the same way as a flexible cover would be removed from a storage tray, for example. Removing the base element 42, when the body element 44 rests on its seating platform, facilitates removal of the contents, both by the cooking space 62 and by the possibility of exerting pressure on the cooked material found therein.

As an option, a lid element 66 can be provided, which plugs the open part of the vessel volume 62, on the first end face 54 of the body element 44. This lid element rests on the internal surface of the sidewall 46, and not on the seating platform of the body element 44. In order to achieve this, the sidewall is flared, at least in the region of its first end face.

As an option, assembly of the lid element 66 and the body element 44 can be undertaken using an assembly device corresponding to the assembly device 1 illustrated in FIG. 1.

The jacket wall 46 in this case has a general form that opens out from the first end phase 50 to the second end phase 54. This particular form further facilitates removal of the contents.

It follows that the engagement surface of the engagement rim 52 forms an angle, that is obtuse, with the general form of the jacket wall 46.

The thickness of the jacket wall 46 decreases progressively, from the first end face 50 to the second end face 52 of the body element 44.

The jacket wall 46 has an internal surface 68 that connects to the second side of the engagement rim 52 by a rounded or pointed portion.

The assembly device 1 is particularly suitable for elements that are predominantly produced, or even exclusively produced, from silicone or similar material. Such elements are highly flexible, in particular they are extremely malleable, which makes their mutual assembly awkward. The device used notably must be strong and must maintain its tightness under all circumstances, despite the potentially considerable deformation of the elements that it assembles. Furthermore, such elements are completely, or almost completely, resilient, that is, they rapidly and identically return to their initial shape once the deformation forces applied thereto cease. Therefore, the assembly device used must not lose this property.

Further embodiments can be envisaged from the aforementioned embodiments. For example:
only the engagement rim 52 and the receiving groove 64 can be made from silicone, for example, by over moulding a portion in silicone onto a portion made from another material, for example, aluminium. In other words, the fact that the engagement rim 3 and the receiving groove 5 are made from silicone does not mean that the elements that they assemble are themselves made from silicone.
only one zone of the base element 42, in which the receiving groove 52 is formed, can be made from silicone.
a first side 7 has been described that is practically formed by the notch 19 and the rib 21, exclusively. As a variant, the first side 7 can extend beyond the rib 21, and/or the notch 19 can be arranged remote from the base of the side 17.
the base 17 of the receiving groove 5 can, together with the connection surface 11 of the engagement rim 3, form a free space of a selected value. In this case, the first side 13 and the second side 15 of the receiving groove 5 have surfaces, the shapes of which complement the first side 7 and the second side 9 of the engagement rim 3, but which extend up to the base 17.
the value of the angle of inclination Al can be adapted according to the selected application. In this case, it depends on the internal volume and is selected so as to obtain optimal conicity. In other words, the first angle A1 can assume a fairly important role in terms of the strength and the tightness of the assembly.
the implementation of the assembly device 1 is not limited to cooking dishes. Other applications are already envisaged, such as the assembly of a food container and its lid, for example.
the tightness and the strength of the assembly device 1 can be adapted to the envisaged application by producing elements that form the utensil and/or the engagement rim 3 and the receiving groove 5 in such a way that they have different rigidities and by adapting these rigidities relative to one another.
even though the assembly device 1 is more specifically designed for elements that together form a kitchen utensil, it is not inconceivable that it can be used in other fields, for applications in which the tightness of the assembly is of the utmost importance, such as can be found in the general foods field, or even in the fields of medicine, pharmaceuticals, or even cosmetics, notably for manufacturing storage receptacles.
the assembly device 1 can be used for flexible elements, as previously described, but also for a flexible element, for example that is made from silicone, polyolefin, thermoplastic elastomers/vulcanized thermoplastic elastomers, and a rigid element, or that is at least relatively rigid, for example a thermoplastics material, composite, metal, or glass material or even extremely hard rubbers.
the assembly device 1 can also be used to connect two portions of the same part in a reversible manner, for example, two opposite edges of a bag produced from a single piece. In other words, this device is not limited to the assembly of two elements that are totally separate from one another.
The assembly device 1 can also be used in any application for which a sufficient tightness between two elements is required. This particularly involves the manufacture of storage receptacles in the alimentary fields, but also in the medical, pharmaceutical or even cosmetics fields.
According to the invention, both the engagement rim 3 and the receiving groove 5 are made from silicone or are formed from material of this type. For most applications, the same silicone will be used to produce the engagement rim 3 and the receiving groove 5, especially for economical and practical reasons. However, specific applications can make it necessary, or at least desirable, to use different silicones, for example because more flexibility is required for one of the elements than for the other or, inversely, greater rigidity is required, or even because the use stipulates the implementation of a particular material for producing either the engagement rim 3 or the receiving groove 5. A particular application can also determine the use of metal or plastics material for producing the engagement rim 3 or the receiving groove 5. Furthermore, a particular material, such as any flexible material, can also be stipulated by the application for the other one of these elements.
There are numerous other elements that together constitute a kitchen utensil. In each case, the elements that constitute the main utensil and its accessory can be linked together in a reversible manner, and practically as seems fit. Depending on the case, the connection implemented exhibits very different strength and tightness characteristics, which are adapted to the usage conditions, which are generally specific to a given utensil. For example, the lid of a saucepan is not securely fixed thereto, so it can be easily removed, especially without moving the saucepan. The lid and the saucepan are not, strictly speaking, joined together. In general, the lid has a flat surface which bears against a rim of the saucepan. The weight of the lid ensures that contact is maintained between the bearing surface and the relevant rim. The tightness of this device basically depends on the flatness of the bearing surface and the flange. The strength of the device depends on the weight of the lid. When the pressure increases in the enclosure, the lid lifts off and the discharge returns the pressure to an acceptable level. The strength of the “assembly” is low, as this type of device does not provide for holding the lid together with the saucepan.
The assembly device 1 proposed herein can be used in numerous cases in which assembly that is both firm and reversible is required.

The invention is not limited to the aforementioned embodiments, which have been provided by way of example only, but incorporates all other variants that can be envisaged by a person skilled in the art.

1. Assembly device for a kitchen utensil, comprising an engagement rim formed on a first element of said utensil and a groove for receiving said engagement rim, formed in a second element of said utensil, characterised in that said engagement rim is made from silicone, that said receiving groove is formed in a silicone portion of said second element, and in that said engagement rim has a side with a rib and a notch that are mutually adjacent, whereas said receiving groove has a side that is shaped at least in part to complement said side of said engagement rim.

2. Device according to claim 1, wherein said engagement rim also has an additional side mainly having a uniform surface, and wherein said receiving groove also has an additional side having at least one portion that is complementary to said additional side of said engagement rim.

3. Device according to claim 2, wherein said additional side of said engagement rim extends generally obliquely relative to said side of said engagement rim.

4. Device according to claim 2, wherein said engagement rim also has an end face connecting said side to said additional side, and wherein said receiving groove has a base that is formed so as to be complementary to said end face of said engagement rim.

5. Device according to claim 4, wherein said end face is generally flat.

6. Device according to claim 1, wherein said rib of said engagement rim has a uniform upper surface.

7. Device according to claim 6, wherein said upper surface of said rib attaches directly to said notch.

8. Device according to claim 6, wherein said upper surface of said rib attaches directly to an end face of said engagement rim.

9. Device according to claim 8, wherein said upper surface of said rib and said end face of said engagement rim are arranged perpendicular to one another.

10. Device according to claim 1, wherein said engagement rim and said receiving groove have cross-sections of complementary shape.

11. Device according to claim 1, wherein said side of said engagement rim is generally straight.

12. Device according to claim 1 wherein said notch has a cross-section that is circular at least in part.

13. Kitchen utensil, comprising a first element provided with an engagement rim and a second element provided with a groove for receiving said engagement rim, characterised in that said engagement rim is made from silicone, that said receiving groove is formed in a silicone portion of said second element, and in that said engagement rim has a side with a rib and a notch that are mutually adjacent, whereas said receiving groove has a side that is shaped at least in part to be complementary to said side of said engagement rim.

14. Kitchen utensil according to claim 13, wherein the first element comprises a closed side wall supporting said engagement rim, said second element 30 comprises a flat surface bordered by said receiving groove, said flat surface and said closed side wall together defining a vessel volume .

15. Kitchen utensil according to either claim 13, wherein said first element has an end face remote from said engagement rim, wherein said 35 second element has an end face remote from said receiving groove, and wherein said end face of each of said first and second elements comprises a seating platform.
